(19) United States
(12) Patent Application Publication
(10) Pub. No.: US 2026/0343646 A1
(43) Pub. Date: Oct. 29, 2026

(54) METHOD AND APPARATUS FOR MULTI-PATH CASE

(71) Applicant: LENOVO (BEIJING) LIMITED, Beijing (CN)

(72) Inventors: Lianhai WU, Beijing (CN); Jing HAN, Beijing (CN); Ran YUE, Beijing (CN); Min XU, Beijing (CN); Haiming Wang, Beijing (CN)

(21) Appl. No.: 19/110,773

(22) PCT Filed: Sep. 29, 2022
(86) PCT No.: PCT/CN2022/122687

§ 371 Date: Mar. 11, 2025

(51) Int. Cl. H04W 76/15; H04W 88/04

(52) U.S. Cl. CPC H04W 76/15; H04W 88/04

(57) ABSTRACT

Embodiments of the present disclosure relate to methods and apparatuses for multi-path case. According to some embodiments of the disclosure, a user equipment (UE) may include: a processor configured to access a serving base station (BS) via a first path; and a transceiver coupled to the processor and configured to receive, from the serving BS, a reconfiguration message indicating the UE to add a second path; the processor is further configured to perform a path addition procedure to add the second path and start a timer for the path addition procedure in response to receiving the reconfiguration message.

### TECHNICAL FIELD

Embodiments of the present application generally relate to wireless communication technology, especially to a method and apparatus for a multi-path case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a BS or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases.

In a wireless communication system, a UE may operate in a multi-path case. The multi-path may also be named as “multiple paths” or the like. In some examples, the multi-path case may include a direct path and an indirect path via a relay UE. However, details regarding how to add a path for supporting the multi-path case and how to perform a cell change in a multi-path case have not been specifically discussed yet.

### SUMMARY OF THE APPLICATION

Some embodiments of the present application at least provide a technical solution for multi-path case.

According to some embodiments of the present application, a UE may include: a processor configured to access a serving base station (BS) via a first path; and a transceiver coupled to the processor and configured to receive, from the serving BS, a reconfiguration message indicating the UE to add a second path; the processor is further configured to perform a path addition procedure to add the second path and start a timer for the path addition procedure in response to receiving the reconfiguration message.

In some embodiments of the present application, the first path is an indirect path associated with a relay UE between the UE and the serving BS, and the second path is a direct path between the UE and the serving BS.

In some embodiments of the present application, the transceiver is further configured to receive a notification message or a PC5 signaling (PC5-S) release indication from the relay UE or the processor is configured to detect a radio link failure (RLF) on a PC5 link between the UE and the relay UE when the UE is performing the path addition procedure.

In some embodiments of the present application, the processor is further configured to continue to perform the path addition procedure in response to receiving the notification message or the PC5-S release indication or in response to detecting the RLF.

In some embodiments of the present application, in response to receiving the notification message from the relay UE, the transceiver is further configured to perform at least one of: suspending an uplink (UL) transmission on an end-to-end link between the UE and the serving BS; or continuing to receive a downlink (DL) transmission from the relay UE.

In some embodiments of the present application, in response to receiving the PC5-S release indication from the relay UE, the processor is further configured to perform at least one of: releasing an end-to-end link between the UE and the serving BS; or releasing the PC5 link between the UE and the relay UE.

In some embodiments of the present application, in response to detecting the RLF on the PC5 link, the processor is further configured to perform at least one of: suspending an end-to-end link between the UE and the serving BS; or suspending the PC5 link between the UE and the relay UE.

In some embodiments of the present application, the processor is further configured to perform at least one of: releasing an end-to-end link between the UE and the serving BS; or releasing the PC5 link between the UE and the relay UE.

In some embodiments of the present application, in response to that the UE successfully adds the direct path, the transceiver is further configured to transmit failure related information to the serving BS via the direct path, and wherein the failure related information indicates one of: reception of the notification message from the relay UE; reception of the PC5-S release indication from the relay UE; and a detection of the RLF on the PC5 link.

In some embodiments of the present application, in response to that the UE fails to add the direct path, the processor is further configured to initiate a recovery procedure.

In some embodiments of the present application, the processor is further configured to stop performing the path addition procedure and initiate a recovery procedure in response to receiving the notification message or the PC5-S release indication or in response to detecting the RLF.

In some embodiments of the present application, the first path is a direct path between the UE and the serving BS, and the second path is an indirect path associated with a relay UE between the UE and the serving BS.

In some embodiments of the present application, the processor is further configured to: detect an RLF on the direct path between the UE and the serving BS when the UE is performing the path addition procedure; and continue to perform the path addition procedure in response to detecting the RLF.

In some embodiments of the present application, the processor is further configured to: suspend the direct link between the UE and the serving BS; or release the direct link between the UE and the serving BS.

In some embodiments of the present application, in response to that the UE successfully adds the indirect path, the transceiver is further configured to transmit failure related information to the serving BS via the indirect path, and wherein the failure related information indicates a detection of the RLF on the direct path.

In some embodiments of the present application, in response to that the UE fails to add the indirect path, the processor is further configured to initiate a recovery procedure.

In some embodiments of the present application, the processor is further configured to: detect an RLF on the direct path between the UE and the serving BS when the UE is performing the path addition procedure; and in response to detecting the RLF, stop performing the path addition procedure and initiate a recovery procedure.

In some embodiments of the present application, the processor is configured to: stop the timer in response to that the UE successfully completes the path addition procedure; or declare a failure of the path addition procedure once the timer for the path addition procedure expires.

In some embodiments of the present application, the UE is configured with the first path and the second path after stopping the timer, the transceiver is further configured to receive an indication from the relay UE or from the BS, and wherein the indication indicates at least one of: the relay UE switches to a target cell within the serving BS; or the UE to suspend the first path or the second path which is an indirect path between the serving BS and the UE.

In some embodiments of the present application, the processor is further configured to suspend the first path or the second path which is an indirect path, in response to receiving the indication from the relay UE or from the BS.

According to some other embodiments of the present application, a BS may include: a processor configured to communicate with a UE via a first path; a transceiver coupled to the processor and configured to: transmit, to the UE, a reconfiguration message indicating the UE to add a second path; and receive, from the UE, failure related information associated with the first path.

In some embodiments of the present application, the first path is an indirect path associated with a relay UE between the UE and the BS, and the second path is a direct path between the UE and the BS, and wherein the failure related information indicates one of: reception of a notification message from the relay UE; reception of a PC5-S release indication from the relay UE; and a detection of an RLF on a PC5 link between the UE and the relay UE.

In some embodiments of the present application, the first path is a direct path between the UE and the BS, and the second path is an indirect path associated with a relay UE between the UE and the BS, and wherein the failure related information indicates a detection of an RLF on the direct path between the UE and the BS.

According to some embodiments of the present application, a method performed by a UE may include: accessing a serving BS via a first path; receiving, from the serving BS, a reconfiguration message indicating the UE to add a second path; and performing a path addition procedure to add the second path and starting a timer for the path addition procedure in response to receiving the reconfiguration message.

According to some embodiments of the present application, a method performed by a BS may include: communicating with a UE via a first path; transmitting, to the UE, a reconfiguration message indicating the UE to add a second path; and receiving, from the UE, failure related information associated with the first path.

Some embodiments of the present application also provide an apparatus, include: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as stated above with the at least one receiving circuitry, the at least one transmitting circuitry and the at least one processor.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system 100 in accordance with some embodiments of the present application.

FIG. 2 illustrates an exemplary flowchart of a sidelink RRC reconfiguration procedure in accordance with some embodiments of the present application.

FIG. 3 illustrates a schematic diagram of a wireless communication system 300 in accordance with some embodiments of the present application.

FIG. 4 illustrates a schematic diagram of a wireless communication system 400 in accordance with some embodiments of the present application.

FIGS. 5-9 illustrate exemplary flowcharts for path addition according to some embodiments of the present application.

FIGS. 10 and 11 illustrate exemplary flowcharts for cell change according to some embodiments of the present application.

FIG. 12 illustrates a flowchart of an exemplary method for path addition according to some embodiments of the present application.

FIG. 13 illustrates a flowchart of another exemplary method for path addition according to some embodiments of the present application.

FIG. 14 illustrates a simplified block diagram of an apparatus 1400 for multi-path case according to some embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present application are also applicable to similar technical problems; and moreover, the terminologies recited in the present application may change, which should not affect the principle of the present application.

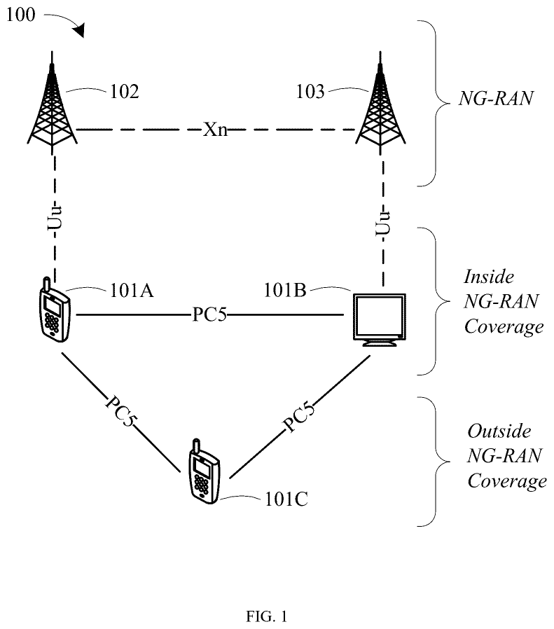

FIG. 1 illustrates a schematic diagram of a wireless communication system 100 in accordance with some embodiments of the present application.

As shown in FIG. 1, the wireless communication system 100 may support sidelink communications. Sidelink communication supports an UE-to-UE direct communication. In the context of the present application, sidelink communications may be categorized according to the wireless communication technologies adopted. For example, sidelink communication may include NR sidelink communication and V2X Sidelink communication.

NR sidelink communications may refer to AS functionality enabling at least V2X communications as defined in 3GPP specification TS 23.287 between neighboring UEs, using NR technology but not traversing any network node. V2X sidelink communications may refer to AS functionality enabling V2X communications as defined in 3GPP specification TS 23.285 between neighboring UEs, using E-UTRA technology, but not traversing any network node. However, if being not specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs are depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present application, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE 101 may include, for example, but is not limited to, a computing device, a wearable device, a mobile device, an IoT device, a vehicle, etc. Persons skilled in the art should understand that as technology develops and advances, the terminologies described in the present application may change, but should not affect or limit the principles and spirit of the present application.

In the example of FIG. 1, the BS 102 and the BS 103 may be included in a next generation radio access network (NG-RAN). In an embodiment of the present application, the BS 102 may be a gNB and the BS 103 may be an ng-eNB.

The UE 101A and UE 101B may be inside NG-RAN coverage. For example, as shown in FIG. 1, the UE 101A may be within the coverage of BS 102, and the UE 101B may be within the coverage of BS 103. The UE 101C may be outside NG-RAN coverage. For example, as shown in FIG. 1, the UE 101C may be outside the coverage of any BSs, for example, both the BS 102 and BS 103. The UE 101A and UE 101B may respectively connect to the BS 102 and BS 103 via a network interface, for example, the Uu interface as specified in 3GPP standard documents. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents.

Support for V2X services via the PC5 interface can be provided by, for example, NR sidelink communication and/or V2X sidelink communication. NR sidelink communication can support one of the following three types of transmission models for a pair of a Source Layer-2 ID and a Destination Layer-2 ID: unicast transmission, groupcast transmission, and broadcast transmission. Sidelink communication transmission and reception over the PC5 interface are supported when the UE is inside NG-RAN coverage and when the UE is outside NG-RAN coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present application.

A V2X UE can operate in different modes. At least two sidelink resource allocation modes are defined for sidelink communication. For example, mode 1 may refer to the situation where a base station schedules sidelink resource(s) to be used by the UE for sidelink transmission(s), and mode 2 may refer to the situation where a UE determines sidelink transmission resource(s) and timing within a resource pool. The resource pool may be configured by a base station or network, or may be pre-configured according to a standard. In mode 2, the base station may not need to dynamically schedule the sidelink resources for the UE, and the UE may determine the sidelink transmission resources and timing in the resource pool based on, for example, a measurement result and a sensing result.

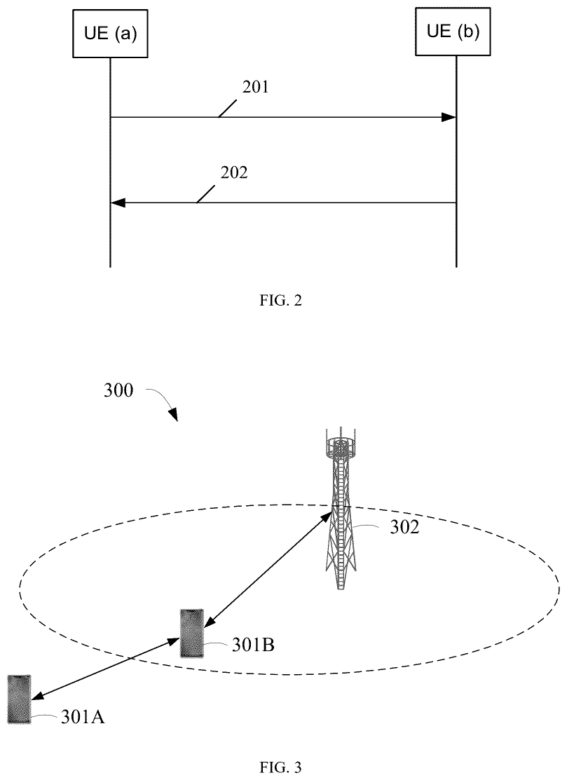

FIG. 2 illustrates an exemplary flowchart of a sidelink RRC reconfiguration procedure in accordance with some embodiments of the present application. As shown in FIG. 2, in operation 201, UE (a) (e.g., UE 101C as illustrated and shown in FIG. 1) initiates a sidelink RRC reconfiguration procedure to UE (b) (e.g., UE 101A as illustrated and shown in FIG. 1) by transmitting an RRCReconfigurationSidelink message to UE (b).

If the sidelink RRC reconfiguration procedure is successfully completed, in operation 202, UE (b) may transmit “an RRC reconfiguration complete sidelink message” to UE (a), e.g., an RRCReconfigurationCompleteSidelink message as specified in 3GPP standard documents. Alternatively, if the sidelink RRC reconfiguration procedure is not successfully completed, in operation 202, UE (b) may transmit “an RRC reconfiguration failure sidelink message” to UE (a), e.g., an RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

In some cases, Uu coverage reachability is necessary for UEs to reach server in public data network (PDN) network or counterpart UE out of proximity area. In order to achieve UE-to-network coverage extension, a UE-to-network relay may be introduced in a wireless communication system. An example for a UE-to-network relay may be referred to as FIG. 3.

FIG. 3 illustrates a schematic diagram of a wireless communication system 300 in accordance with some embodiments of the present application.

As shown in FIG. 3, the wireless communication system 300 may include one BS (e.g., BS 302) and some UEs (e.g., UE 301A and UE 301B). UE 301B may be within the coverage of BS 302, and UE 301A may be out-of-coverage. Although a specific number of UEs and BS are depicted in FIG. 3, it is contemplated that any number of UEs may be included in the wireless communication system 300.

The wireless communication system 300 may support sidelink communications. For example, UE 301B may be in sidelink communication with UE 301A. Although UE 301A is outside the coverage of BS 302, UE 301A may access BS 202 via UE 301B. UE 301A and BS 302 may thus establish a radio resource control (RRC) connection therebetween, and UE 301A may have RRC states, such as an RRC_IDLE state, an RRC_INACTIVE state, and an RRC_CONNECTED state. In the context of the present application, a UE (e.g., UE 301B), which functions as a relay between a UE and a BS, may be referred to a UE-to-network relay. It should be appreciated by persons skilled in the art that although a single relay node between UE 301A and BS 302 is depicted in FIG. 3, it is contemplated that any number of relay nodes may be included.

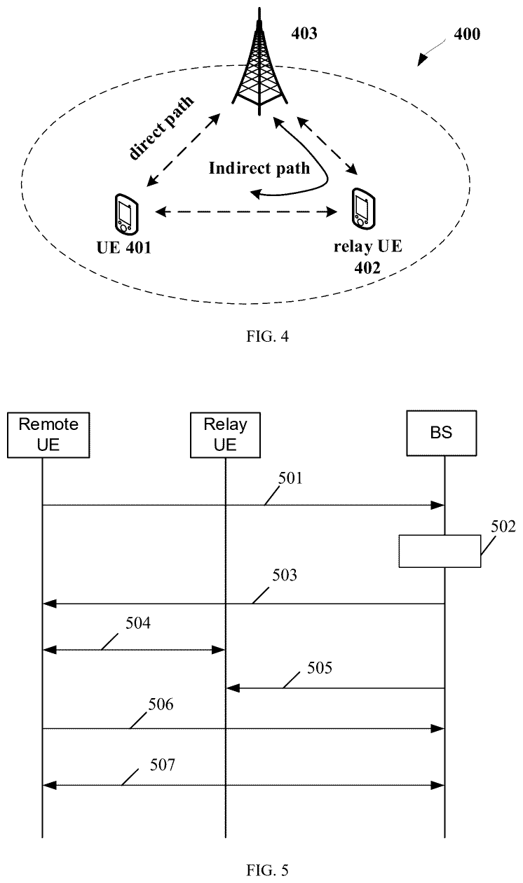

FIG. 4 illustrates a schematic diagram of a wireless communication system 400 in accordance with some embodiments of the present application. As illustrated and shown in FIG. 4, a wireless communication system 400 includes at least two UEs (i.e., UE 401 and relay UE 402) and at least one BS (e.g., BS 403) for illustrative purpose. Although a specific number of UE(s) and BS(s) are depicted in FIG. 4, it is contemplated that any number of UE(s) and BS(s) may be included in the wireless communication system 400. As shown in FIG. 4, the UE 401 may operate in a multi-path case, e.g., the UE 401 may communicate with BS 403 via a direct path (also referred to as direct link) between UE 401 and BS 403 or via an indirect path (also referred to as indirect link) between UE 401 and BS 403 through relay UE 402. The indirect link between UE 401 and BS 403 may include a PC5 link between the UE 401 and relay UE 402 and a link between relay UE 402 and BS 403.

FIG. 5 illustrates an exemplary flowchart for path addition in accordance with some embodiments of the present application. The method illustrated in FIG. 5 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

In the embodiments of FIG. 5, the remote UE may access a serving BS via a Uu link, e.g., a direct path.

In operation 501, the remote UE may report measurement result(s) to the serving BS based on the configuration from the serving BS.

In operation 502, the serving BS may decide to add another indirect path based on the measurement result(s) from the remote UE.

In operation 503, the BS may transmit an RRC reconfiguration message for path addition to the remote UE.

In operation 504, the remote UE establishes PC5 connection with the relay UE indicated by the RRC reconfiguration message.

In operation 505, the serving BS may transmit an RRC reconfiguration message associated with the remote UE to the relay UE.

Once the other indirect path is successfully added, in operation 506, the remote UE may transmit an RRC reconfiguration complete message to the serving BS.

In operation 507, the remote UE may transmit data to the serving BS or receive data from the BS (e.g., via at least one of the direct link or the newly added indirect link.

According to some embodiments of the present application, a UE may access a BS via a first path (e.g., a direct path or an indirect path). The BS may configure the UE to add a second link (e.g., an indirect link or a direct link). In some cases, the first link failure may happen while the UE is performing a path addition procedure to add the second link. In such cases, the UE's behaviour, e.g., how to handle the first link and how to handle the ongoing path addition procedure, needs to be addressed.

According to some embodiments of the present application, a UE may be configured with multiple paths (e.g., a direct path and an indirect path). In some cases, the relay UE in the indirect link may change its serving cell under the same BS. In such cases, the BS′ behaviour, the UE's behaviour, the relay UE's behaviour also need to be addressed.

Given the above, embodiments of the present application aim to provide solutions for multi-path case. For example, embodiments of the present application provide several solutions for path addition and cell change in multi-path case. Accordingly, embodiments of the present application at least can solve the above technical problems, thereby facilitating operations in multi-path case. More details on embodiments of the present application will be illustrated in the following text in combination with the appended drawings.

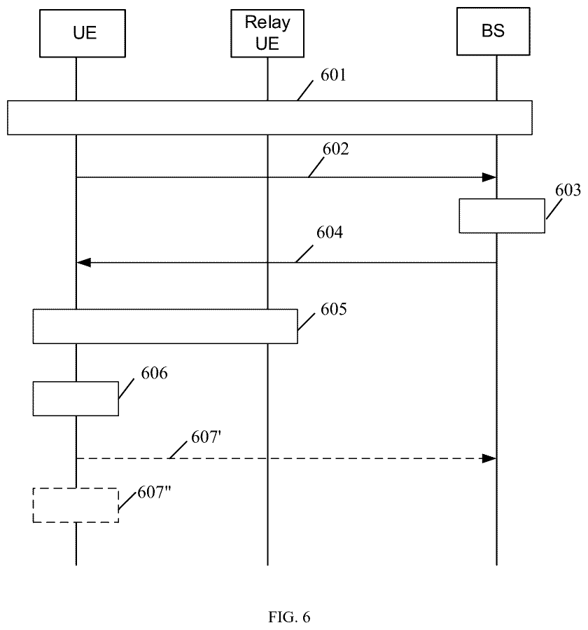

FIG. 6 illustrates a further exemplary flowchart for path addition according to some embodiments of the present application. The method illustrated in FIG. 6 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

Referring to FIG. 6, in operation 601, the UE may access a serving BS via a first path. Accordingly, the BS may communicate with the UE via a first path. The first path in FIG. 6 may be an indirect path associated with a relay UE between the UE and the serving BS. The indirect path may also be referred to as an indirect link, an end-to-end path, or an end-to-end link. The indirect link may include a PC5 link between the UE and the relay UE and a Uu link between the relay UE and the BS. The UE may stay at an RRC-connected state.

In operation 602, the UE may transmit, to the serving BS, measurement result(s) based on configuration from the serving BS.

In operation 603, based on the measurement result(s) from the UE, the serving BS may determine to add a second path. The second path may be a direct path between the UE and the BS. The direct path may also be referred to as a direct link or a Uu link.

In operation 604, the serving BS may transmit a reconfiguration message indicating the UE to add a second path. For example, the reconfiguration message may be an RRC reconfiguration message as specified in 3GPP standard documents. In some embodiments, the reconfiguration message may include a target cell identify (ID).

In response to receiving the reconfiguration message, in operation 605, the UE may perform a path addition procedure to add the second path and start a timer for the path addition procedure. For example, the timer may be T304 as specified in TS 38.331.

In operation 605, the UE may receive a notification message or a PC5-S release indication from the relay UE or the UE detect a RLF on a PC5 link between the UE and the relay UE when the UE is performing the path addition procedure.

In operation 606, the UE may continue to perform the path addition procedure in response to receiving the notification message or the PC5-S release indication or in response to detecting the RLF.

In some embodiments, the UE may receive the notification message from the relay UE in operation 605. In an embodiment, the notification message may indicate at least one of:
(1) a Uu RLF between the relay UE and the network;
(2) a cell reselection of the relay UE;
(3) a handover of the relay UE;
(4) an RRC connection failure of the relay UE;
(5) an RRC connection rejection message received by the relay UE;
(6) an expiry of a timer for RRC setup request at the relay UE;
(7) an RRC resume failure of the relay UE; or
(8) any other information.

In such embodiments, in response to receiving the notification message from the relay UE, in operation 606, the UE may perform at least one of: suspending an UL transmission on an end-to-end link between the UE and the serving BS; or continuing to receive a DL transmission from the relay UE.

In some other embodiments of the present application, in operation 605, the UE may receive the PC5-S release indication from the relay UE. For example, the UE may receive an indication indicating PC5-S release from an upper layer (e.g., PC5-S layer).

In such embodiments, in response to receiving the PC5-S release indication from the relay UE, in operation 606, the UE may perform at least one of: releasing an end-to-end link between the UE and the serving BS; or releasing the PC5 link between the UE and the relay UE.

In some other embodiments of the present application, in operation 605, the UE may detect the RLF on the PC5 link. In such embodiments, in response to detecting the RLF on the PC5 link, in operation 606, the UE may perform at least one of: suspending an end-to-end link between the UE and the serving BS; or suspending the PC5 link between the UE and the relay UE.

In some other embodiments of the present application, in response to receiving the notification message or the PC5-S release indication or in response to detecting the RLF in operation 605, in operation 606, the UE may perform at least one of: releasing an end-to-end link between the UE and the serving BS; or releasing the PC5 link between the UE and the relay UE.

In some cases, the UE may successfully add the direct path (e.g., the UE successfully completes the path addition procedure before the timer expires). Then, in operation 607′, the UE may transmit failure related information to the serving BS via the direct path. In some embodiments, the failure related information may be included in an RRC message (e.g., an RRC reconfiguration complete message as specified in 3GPP standard documents).

The failure related information may include an indication indicating one of: reception of the notification message from the relay UE; reception of the PC5-S release indication from the relay UE; and a detection of the RLF on the PC5 link.

In an embodiment, in the case that the indication included in the failure related information indicates reception of the notification message from the relay UE, the failure related information may also include an indication type, for example, the indication type may indicate the content indicated by notification message as stated above.

In an embodiment, the failure related information may also include measurement result(s) of candidate relays such that the serving BS may reconfigure a new candidate relay to UE.

In some other cases, the UE may fail to add the direct path (e.g., the timer for the path addition procedure expires). Then, in operation 607″, the UE may initiate a recovery procedure, e.g., performing a re-establishment procedure.

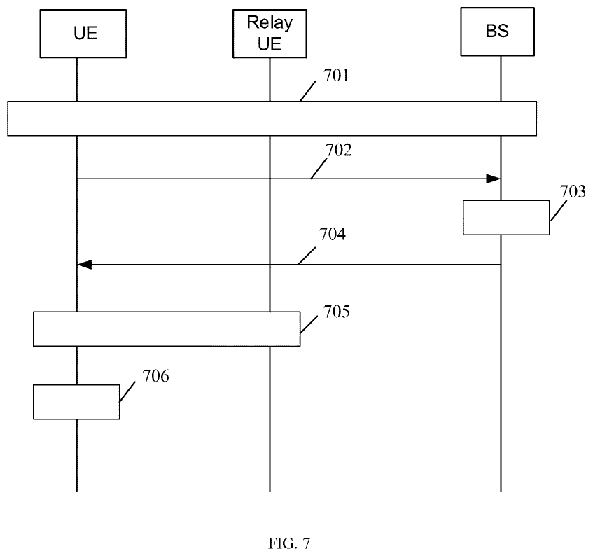

FIG. 7 illustrates another exemplary flowchart for path addition according to some embodiments of the present application. The method illustrated in FIG. 7 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

Referring to FIG. 7, operations 701-705 may be the same as operations 601-605, respectively. The difference between FIG. 7 and FIG. 6 is operation 706.

Specifically, in operation 706, the UE may stop performing the path addition procedure and initiate a recovery procedure (e.g., perform a re-establishment procedure) in response to receiving the notification message or the PC5-S release indication or in response to detecting the RLF.

In the embodiments of FIG. 7, the first path (e.g., indirect path) may be a primary path.

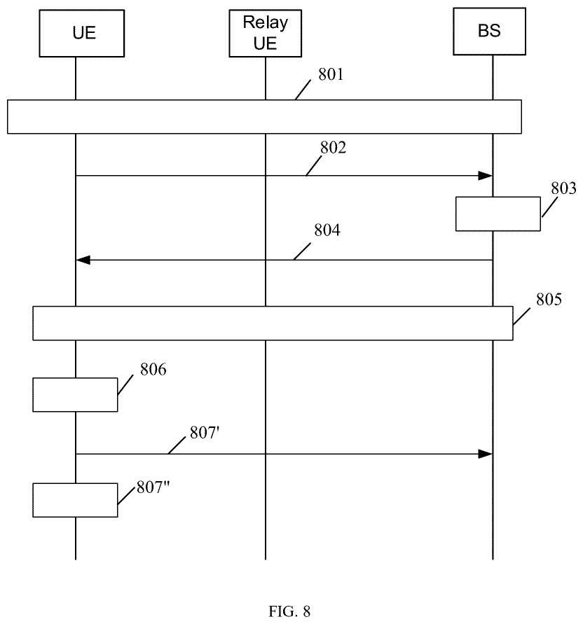

FIG. 8 illustrates yet another exemplary flowchart for path addition according to some embodiments of the present application. The method illustrated in FIG. 8 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

Referring to FIG. 8, in operation 801, the UE may access a serving BS via a first path. Accordingly, the BS may communicate with the UE via a first path. The first path may be a direct path between the UE and the BS. The direct path may also be referred to as a direct link or a Uu link. The UE may stay at an RRC-connected state.

In operation 802, the UE may transmit, to the serving BS, measurement result(s) based on configuration from the serving BS.

In operation 803, based on the measurement result(s) from the UE, the serving BS may determine to add a second path. The second path in FIG. 8 may be an indirect path associated with a relay UE between the UE and the serving BS. The indirect path may also be referred to as an indirect link, an end-to-end path, or an end-to-end link. The indirect link may include a PC5 link between the UE and the relay UE and a Uu link between the relay UE and the BS.

In operation 804, the serving BS may transmit a reconfiguration message indicating the UE to add a second path. For example, the reconfiguration message may be an RRC reconfiguration message as specified in 3GPP standard documents. In some embodiments, the reconfiguration message may include an ID of a relay UE.

In response to receiving the reconfiguration message, in operation 805, the UE may perform a path addition procedure to add the second path and start a timer for the path addition procedure. For example, the timer may be T420 as specified in TS 38.331.

In operation 805, the UE may detect a RLF on the direct path between the UE and the serving BS when the UE is performing the path addition procedure.

In operation 806, the UE may continue to perform the path addition procedure in response to detecting the RLF. In some embodiments of the present application, the UE may suspend the direct link between the UE and the serving BS in operation 806. Alternatively, the UE may release the direct link between the UE and the serving BS in operation 806.

In some cases, the UE may successfully add the indirect path (e.g., the UE successfully completes the path addition procedure before the timer expires). Then, in operation 807′, the UE may transmit failure related information to the serving BS via the indirect path. In some embodiments, the failure related information may be included in an RRC message (e.g., an RRC reconfiguration complete message as specified in 3GPP standard documents). For example, the failure related information may indicate a detection of the RLF on the direct path.

In some other cases, the UE may fail to add the direct path (e.g., the timer for the path addition procedure expires). Then, in operation 807″, the UE may initiate a recovery procedure, e.g., perform a re-establishment procedure.

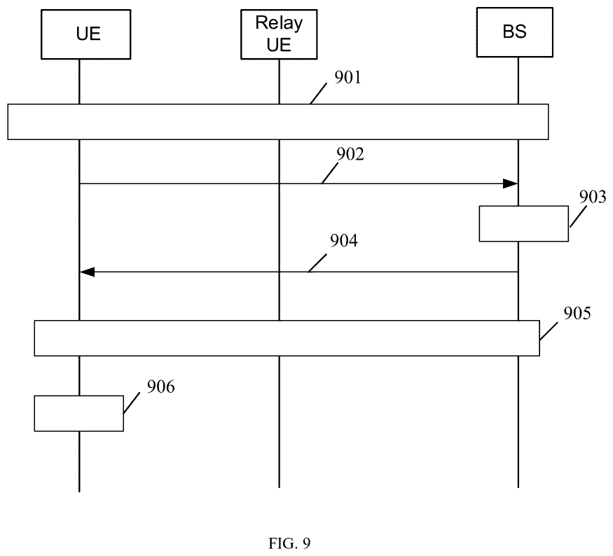

FIG. 9 illustrates yet another exemplary flowchart for path addition according to some embodiments of the present application. The method illustrated in FIG. 9 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

Referring to FIG. 9, operations 901-905 may be the same as operations 801-805, respectively. The difference between FIG. 9 and FIG. 8 is operation 906.

Specifically, in operation 906, the UE may stop performing the path addition procedure and initiate a recovery procedure (e.g., perform a re-establishment procedure) in response to detecting the RLF on the direct path between the UE and the serving BS.

In the embodiments of FIG. 9, the first path (e.g., direct path) may be a primary path.

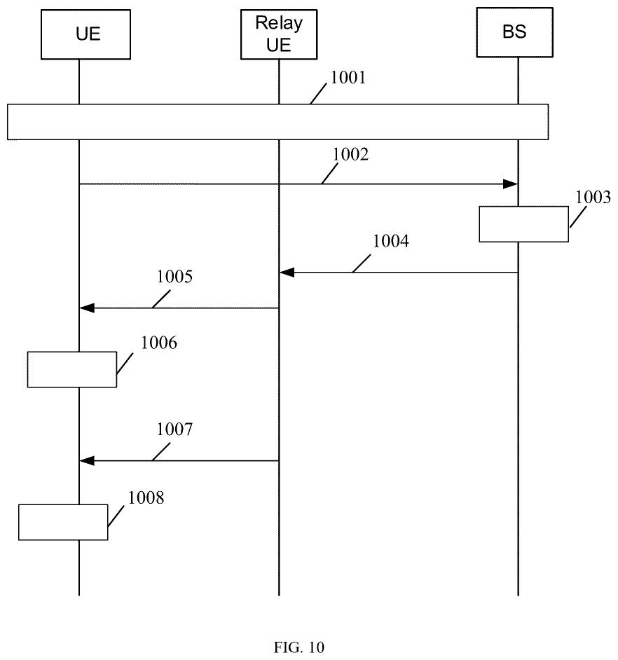

FIG. 10 illustrates an exemplary flowchart for cell change according to some embodiments of the present application. The method illustrated in FIG. 10 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

Referring to FIG. 10, in operation 1001, the UE may access a serving BS. The UE may stay at an RRC-connected state. In operation 1001, the BS may transmit a reconfiguration message including multiple paths configuration (e.g. configurations for multiple paths) to the UE. For example, the multiple paths may include a direct path between the UE and the serving BS and an indirect path associated with a relay UE between the UE and the serving BS.

The direct path may also be referred to as a direct link or a Uu link.

The indirect path may also be referred to as an indirect link, an end-to-end path, or an end-to-end link. The indirect link may include a PC5 link between the UE and the relay UE and a Uu link between the relay UE and the BS.

In operation 1002, the UE may transmit, to the serving BS, measurement result(s) based on configuration from the serving BS.

In operation 1003, based on the measurement result(s) from the UE, the serving BS may determine to a change a serving cell of the relay UE.

In operation 1004, the BS may transmit, to the relay UE, a reconfiguration message indicating a cell change (also referred to as cell handover, or a handover) of the relay UE. For example, the reconfiguration message may be an RRC reconfiguration message as specified in 3GPP standard documents. In some embodiments, the reconfiguration message may include an ID of a target cell to which the relay UE may change (or switch). Alternatively or additionally, the reconfiguration message may also indicate that the relay UE to transmit an indication to the UE, indicating the UE to suspend the indirect path between the serving BS and the UE (or indicating that the UE to keep the multiple paths configured by the BS).

In response to receiving the reconfiguration message, in operation 1005, the relay UE may perform the cell change procedure and transmit an indication to the UE indicating the UE to suspend the indirect path between the serving BS and the UE (or indicating that the UE to keep the multiple paths configured by the BS). In some embodiments, the indication may be transmitted in a notification message for sidelink.

In response to receiving the indication, in operation 1006, the UE may perform at least one of: suspending the indirect path; or keeping the multiple paths configured by the BS.

In the case that the cell change procedure is successfully performed by the relay UE, in operation 1007, the relay UE may transmit, to the UE, an indication indicating the UE to resume the suspended indirect path.

In operation 1008, the UE may resume the suspended indirect path in response to receiving the indication indicating the UE to resume the suspended indirect path.

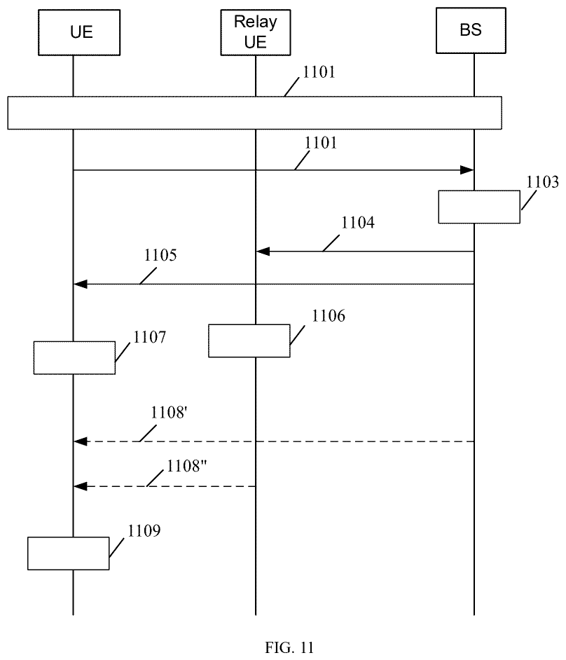

FIG. 11 illustrates a further exemplary flowchart for cell change according to some embodiments of the present application. The method illustrated in FIG. 11 may be performed by a UE (also referred to as a remote UE, e.g., UE 401 in FIG. 4), a relay UE (e.g., UE 402 in FIG. 4), and a BS (also referred to a serving BS of the remote UE, e.g., BS 403 in FIG. 4). Although the method is illustrated in a system level, persons skilled in the art can understand that the method implemented in the two network nodes can be separately implemented and incorporated in other apparatus with the like functions.

Referring to FIG. 11, operations 1101-1103 may be the same as operations 1001-1003, respectively.

In operation 1104, the BS may transmit, to the relay UE, a reconfiguration message indicating a cell change of the relay UE. For example, the reconfiguration message may be an RRC reconfiguration message as specified in 3GPP standard documents. In some embodiments, the reconfiguration message may include an ID of a target cell to which the relay UE may change (or switch).

In operation 1105, the BS may transmit an indication to the UE. The indication may indicate at least one of: the relay UE switches to a target cell within the serving BS (or the UE is about to perform a cell change to a target cell, or the UE is performing a cell change to the target cell); or the UE to suspend the indirect path between the serving BS and the UE (or the UE to keep the multiple paths configured by the BS). In some embodiments, the indication may be transmitted in a reconfiguration message (e.g., RRC reconfiguration message as specified in 3GPP standard documents) to the UE.

In response to receiving the reconfiguration message, in operation 1106, the relay UE may perform the cell change procedure.

In response to receiving the indication, in operation 1107, the UE may perform at least one of: suspending the indirect path; or keeping the multiple paths configured by the BS.

In the case that the cell change procedure is successfully performed by the relay UE (i.e., the successful cell change), in operation 1108′, the relay UE may transmit, to the UE, an indication indicating the UE to resume the suspended indirect path (or indicating the successful cell change of the relay UE). Alternatively, in operation 1108″, the BS may transmit, to the UE, an indication indicating the UE to resume the suspended indirect path (or indicating that the successful cell change of the relay UE).

In operation 1109, the UE may resume the suspended indirect path in response to receiving the indication indicating the UE to resume the suspended indirect path from the relay UE or from the BS.

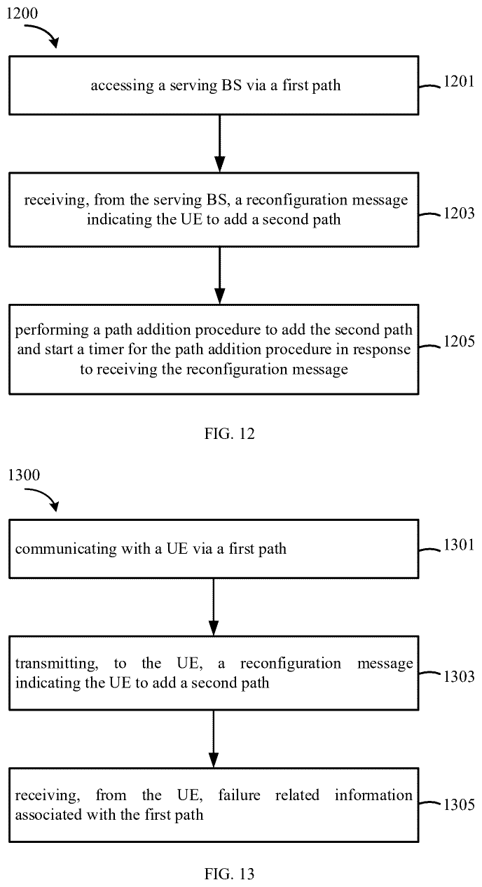

FIG. 12 illustrates a flowchart of an exemplary method for path addition according to some embodiments of the present application. The method in FIG. 12 may be implemented by a UE (e.g., a remote UE 401 as shown in FIG. 4).

In the exemplary method shown in FIG. 12, in operation 1201, the UE may access a serving BS via a first path. In operation 1203, the UE may receive, from the serving BS, a reconfiguration message indicating the UE to add a second path. In operation 1205, the UE may perform a path addition procedure to add the second path and start a timer for the path addition procedure in response to receiving the reconfiguration message.

According to some embodiments of the present application, the first path may be an indirect path associated with a relay UE between the UE and the serving BS, and the second path may be a direct path between the UE and the serving BS. The examples may be referred to FIGS. 6 and 7.

In such embodiments, the UE may receive a notification message or a PC5-S release indication from the relay UE or the UE may detect an RLF on a PC5 link between the UE and the relay UE when the UE is performing the path addition procedure.

In some embodiments of the present application, the UE continue to perform the path addition procedure in response to receiving the notification message or the PC5-S release indication or in response to detecting the RLF. An example may be referred to FIG. 6.

In an embodiment, in response to receiving the notification message from the relay UE, the UE may perform at least one of: suspending an UL transmission on an end-to-end link between the UE and the serving BS; or continuing to receive a DL transmission from the relay UE.

In another embodiment, in response to receiving the PC5-S release indication from the relay UE, the UE may perform at least one of: releasing an end-to-end link between the UE and the serving BS; or releasing the PC5 link between the UE and the relay UE.

In yet another embodiment, in response to detecting the RLF on the PC5 link, the UE may perform at least one of: suspending an end-to-end link between the UE and the serving BS; or suspending the PC5 link between the UE and the relay UE.

In yet another embodiment, in response to receiving the notification message or the PC5-S release indication or in response to detecting the RLF, the UE may perform at least one of: releasing an end-to-end link between the UE and the serving BS; or releasing the PC5 link between the UE and the relay UE.

In some cases, in response to that the UE successfully adds the direct path, the UE may transmit failure related information to the serving BS via the direct path. The failure related information may indicate one of: reception of the notification message from the relay UE; reception of the PC5-S release indication from the relay UE; and a detection of the RLF on the PC5 link.

In some other cases, in response to that the UE fails to add the direct path, the UE may initiate a recovery procedure.

In some other embodiments of the present application, the UE may stop performing the path addition procedure and initiate a recovery procedure in response to receiving the notification message or the PC5-S release indication or in response to detecting the RLF. An example may be referred to FIG. 7.

According to some embodiments of the present application, the first path is a direct path between the UE and the serving BS, and the second path is an indirect path associated with a relay UE between the UE and the serving BS. An example may be referred to FIGS. 8 and 9.

In some embodiments, the UE may detect an RLF on the direct path between the UE and the serving BS when the UE is performing the path addition procedure. Then, the UE may continue to perform the path addition procedure in response to detecting the RLF. An example may be referred to FIG. 8.

In an embodiment, in response to detecting the RLF, the UE may suspend the direct link between the UE and the serving BS; or release the direct link between the UE and the serving BS.

In some cases, in response to that the UE successfully adds the indirect path, the UE may transmit failure related information to the serving BS via the indirect path. The failure related information may indicate a detection of the RLF on the direct path.

In some other cases, in response to that the UE fails to add the indirect path, the UE may initiate a recovery procedure.

In some other embodiments, the UE may detect an RLF on the direct path between the UE and the serving BS when the UE is performing the path addition procedure. Then, in response to detecting the RLF, the UE may stop performing the path addition procedure and initiate a recovery procedure. An example may be referred to FIG. 9.

In the above embodiments, the UE may stop the timer in response to that the UE successfully completes the path addition procedure; or declare a failure of the path addition procedure once the timer for the path addition procedure expires.

The UE is configured with the first path and the second path after stopping the timer. In some cases, the UE may receive an indication from the relay UE (see FIG. 10) or from the BS (see FIG. 11). The indication may indicate at least one of: the relay UE switches to a target cell within the serving BS; or the UE to suspend the first path or the second path which is an indirect path between the serving BS and the UE.

Then, the UE may suspend the first path or the second path which is an indirect path, in response to receiving the indication from the relay UE or from the BS.

FIG. 13 illustrates a flowchart of another exemplary method for path addition according to some embodiments of the present application. The method in FIG. 13 may be implemented by a BS (e.g., a serving BS 403 as shown in FIG. 4).

In the exemplary method shown in FIG. 13, in operation 1301, the BS may be communicate with a UE (e.g., a remote UE 401) via a first path. In operation 1303, the BS may transmit to the UE, a reconfiguration message indicating the UE to add a second path. In operation 1305, the BS may receive, from the UE, failure related information associated with the first path.

In some embodiments, the first path is an indirect path associated with a relay UE between the UE and the BS, and the second path is a direct path between the UE and the B. In such embodiments, the failure related information indicates one of: reception of a notification message from the relay UE; reception of a PC5-S release indication from the relay UE; and a detection of an RLF on a PC5 link between the UE and the relay UE. An example may be referred to FIG. 6.

In some other embodiments, the first path is a direct path between the UE and the BS, and the second path is an indirect path associated with a relay UE between the UE and the BS. In such embodiments, the failure related information may indicate a detection of an RLF on the direct path between the UE and the BS. An example may be referred to FIG. 8.

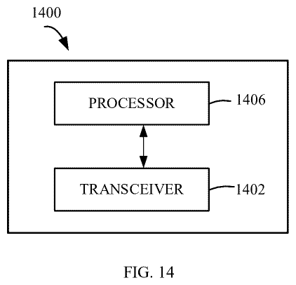

FIG. 14 illustrates a simplified block diagram of an exemplary apparatus for multi-path case according to some embodiments of the present disclosure. As shown in FIG. 14, the apparatus 1400 may include at least one processor 1406 and at least one transceiver 1402 coupled to the processor 1406. The apparatus 1400 may be a UE or an apparatus with the same function, a relay UE or an apparatus with the same function, or a BS or an apparatus with the same function.

Although in this figure, elements such as the at least one transceiver 1402 and processor 1406 are described in the singular, the plural is contemplated unless a limitation to the singular is explicitly stated. In some embodiments of the present disclosure, the transceiver 1402 may be divided into two devices, such as a receiving circuitry and a transmitting circuitry. In some embodiments of the present disclosure, the apparatus 1400 may further include an input device, a memory, and/or other components.

In some embodiments of the present disclosure, the apparatus 1400 may be a UE (e.g., remote UE 401). The transceiver 1402 and the processor 1406 may interact with each other so as to perform the operations with respect to the UE described in FIGS. 1-13. In some embodiments of the present disclosure, the apparatus 1400 may be a relay UE. The transceiver 1402 and the processor 1406 may interact with each other so as to perform the operations with respect to the relay UE described in FIGS. 1-13. In some embodiments of the present disclosure, the apparatus 1400 may be a BS. The transceiver 1402 and the processor 1406 may interact with each other so as to perform the operations with respect to the BS described in FIGS. 1-13.

In some embodiments of the present disclosure, the apparatus 1400 may further include at least one non-transitory computer-readable medium.

For example, in some embodiments of the present disclosure, the non-transitory computer-readable medium may have stored thereon computer-executable instructions to cause the processor 1406 to implement the method with respect to the UE as described above. For example, the computer-executable instructions, when executed, cause the processor 1406 interacting with transceiver 1402 to perform the operations with respect to the UE described in FIGS. 1-13.

For example, in some embodiments of the present disclosure, the non-transitory computer-readable medium may have stored thereon computer-executable instructions to cause the processor 1406 to implement the method with respect to the relay UE as described above. For example, the computer-executable instructions, when executed, cause the processor 1406 interacting with transceiver 1402 to perform the operations with respect to the relay UE described in FIGS. 1-13.

In some embodiments of the present disclosure, the non-transitory computer-readable medium may have stored thereon computer-executable instructions to cause the processor 1406 to implement the method with respect to the BS as described above. For example, the computer-executable instructions, when executed, cause the processor 1406 interacting with transceiver 1402 to perform the operations with respect to the BS described in FIGS. 1-13.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or 14s of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
access a serving base station (BS) via a first path;
receive, from the serving BS, a reconfiguration message indicating the UE to add a second path; and
perform a path addition procedure to add the second path and start a timer for the path addition procedure in response to receiving the reconfiguration message.

2. The UE of claim 1, wherein the first path is an indirect path associated with a relay UE between the UE and the serving BS, and the second path is a direct path between the UE and the serving BS.

3. The UE of claim 2, wherein the at least one processor is further configured to cause the UE to: receive a notification message or a PC5 signaling (PC5-S) release indication from the relay UE or detect a radio link failure (RLF) on a PC5 link between the UE and the relay UE when the UE is performing the path addition procedure.

4. The UE of claim 3, wherein the at least one processor is further configured to cause the UE to continue to perform the path addition procedure in response to receiving the notification message or the PC5-S release indication or in response to detecting the RLF.

5. The UE of claim 4, wherein in response to receiving the notification message from the relay UE, the at least one processor is further configured to cause the UE to perform at least one of:
suspending an uplink (UL) transmission on an end-to-end link between the UE and the serving BS; or
continuing to receive a downlink (DL) transmission from the relay UE.

6. The UE of claim 4, wherein in response to receiving the PC5-S release indication from the relay UE, the at least one processor is further configured to cause the UE to perform at least one of:
releasing an end-to-end link between the UE and the serving BS; or
releasing the PC5 link between the UE and the relay UE.

7. The UE of claim 4, wherein in response to detecting the RLF on the PC5 link, the at least one processor is further configured to cause the UE to perform at least one of:
suspending an end-to-end link between the UE and the serving BS; or
suspending the PC5 link between the UE and the relay UE.

8. The UE of claim 4, wherein, the at least one processor is further configured to cause the UE to perform at least one of:
releasing an end-to-end link between the UE and the serving BS; or
releasing the PC5 link between the UE and the relay UE.

9. The UE of claim 4, wherein in response to that the UE successfully adding the direct path, the at least one processor is further configured to cause the UE to transmit failure related information to the serving BS via the direct path, and wherein the failure related information indicates one of:
reception of the notification message from the relay UE;
reception of the PC5-S release indication from the relay UE; and
a detection of the RLF on the PC5 link.

10. The UE of claim 4, wherein in response to the UE failing to add the direct path, the at least one processor is further configured to cause the UE to initiate a recovery procedure.

11. The UE of claim 4, wherein the at least one processor is further configured to cause the UE to stop performing the path addition procedure and initiate a recovery procedure in response to receiving the notification message or the PC5-S release indication or in response to detecting the RLF.

12. The UE of claim 1, wherein the first path is a direct path between the UE and the serving BS, and the second path is an indirect path associated with a relay UE between the UE and the serving BS.

13. The UE of claim 12, wherein the at least one processor is further configured to cause the UE to:
detect a radio link failure (RLF) on the direct path between the UE and the serving BS when the UE is performing the path addition procedure; and
continue to perform the path addition procedure in response to detecting the RLF.

14. (canceled)

15. A method performed by a user equipment (UE), the method comprising:
accessing a serving base station (BS) via a first path;
receiving, from the serving BS, a reconfiguration message indicating the UE to add a second path; and
performing a path addition procedure to add the second path and starting a timer for the path addition procedure in response to receiving the reconfiguration message.

16. The method of claim 15, wherein the first path is a direct path between the UE and the serving BS, and the second path is an indirect path associated with a relay UE between the UE and the serving BS.

17. The method of claim 15, further comprising:
detecting a radio link failure (RLF) on the direct path between the UE and the serving BS when the UE is performing the path addition procedure; and
in response to detecting the RLF, stop performing the path addition procedure and initiate a recovery procedure.

18. The UE of claim 12, wherein the at least one processor is further configured to cause the UE to:
detect a radio link failure (RLF) on the direct path between the UE and the serving BS when the UE is performing the path addition procedure; and
in response to detecting the RLF, stop performing the path addition procedure and initiate a recovery procedure.

19. A base station (BS) for wireless communication, comprising:
at least one memory; and
at least one processor coupled with the at least one memory and configured to cause the BS to:
communicate with a user equipment (UE) via a first path;
transmit, to the UE, a reconfiguration message indicating the UE to add a second path; and
receive, from the UE, failure related information associated with the first path.

20. The BS of claim 19, wherein the first path is a direct path between the UE and the BS, and the second path is an indirect path associated with a relay UE between the UE and the BS, and wherein the failure related information indicates a detection of a radio link failure (RLF) on the direct path between the UE and the BS.

21. A method performed by a base station (BS), comprising:
communicating with a user equipment (UE) via a first path;
transmitting, to the UE, a reconfiguration message indicating the UE to add a second path; and
receiving, from the UE, failure related information associated with the first path.
